(19) United States
(12) Patent Application Publication
(10) Pub. No.: US 2022/0406176 A1
(43) Pub. Date: Dec. 22, 2022

(54) Traffic Support Systems and Methods

(71) Applicant: Cullen Noah Martin, Chagrin Falls, OH (US)

(72) Inventor: Cullen Noah Martin, Chagrin Falls, OH (US)

(21) Appl. No.: 17/845,028

(22) Filed: Jun. 21, 2022

Related U.S. Application Data
(60) Provisional application No. 63/213,312, filed on Jun. 22, 2021.

(51) Int. Cl. G08G 1/095; G03B 21/20; G03B 21/53; G08G 1/01; G06V 20/54

(52) U.S. Cl. CPC G08G 1/095; G03B 21/2033; G03B 21/2046; G03B 21/2053; G03B 21/53; G08G 1/0141; G08G 1/0145; G08G 1/0125; G08G 1/0116; G06V 20/54; G06V 2201/08

(57) ABSTRACT

Devices and methods for improving the flow of traffic at an intersection are disclosed, such as a traffic light assistance system comprising a light emitter, a light-directing device, a vehicle sensor, a traffic signal detector, and a control unit. The traffic light assistance system can be configured to detect a vehicle and direct projected light toward said vehicle to indicate a change of status of a traffic light. Such devices and methods can alert an operator of a vehicle to a change of status of a traffic light, such as a traffic signal turning green, and indicating that the operator should accelerate the vehicle. By providing means to alert otherwise distracted or inattentive drivers, time spent in traffic can be reduced.

### CROSS-REFERENCE

This application claims the benefit of U.S. Provisional Application No. 63/213,312, titled Traffic Support System, filed Jun. 22, 2021, which is incorporated herein by reference in its entirety and to which application is claimed priority under 35 USC § 120.

### BACKGROUND

A basic problem experienced by many motorists is the blind spots, also referred to as dark spots, of current traffic lights because of their limited light capabilities. Drivers that approach an intersection that has an overhead traffic signal may not pull all the way up to the stop line because they are unable to see the light change when they are close to the traffic signal. Therefore, people have a tendency to stop further behind the stop line than needed. The gap left at the front of each line of traffic reduces the number of cars able to pass through each intersection during a cycle of the traffic light and increases traffic congestion. Further, it can be uncomfortable or even dangerous for those with limited mobility to move their entire body to their dashboard to see the light change. Distracted drivers have delayed reactions to the light change because when they are not looking directly at the traffic light they are unable to see it change. Any and all of these can lead to delays in the flow of traffic and frustration.

### BRIEF SUMMARY

The following presents a simplified summary to provide a basic understanding of some aspects of the claimed subject matter. This summary is not an extensive overview. It is not intended to either identify key or critical elements or to delineate the scope of the claimed subject matter. Its sole purpose is to present some concepts in a simplified form as a prelude to the more detailed description that is presented later.

Inattentive or distracted drivers are susceptible to missing a change of a traffic signal, e.g., a traffic light turning from red to green. Though the inconvenience of a singular car of only a few seconds by itself may not appear large, cumulatively on a national scale, this leads to a vast volume of hours lost in commute time. The devices and methods provided herein address this issue by providing a more noticeable indication of a change of light status.

In various embodiments, the present disclosure provides a traffic light assistance system comprising: a light projector and associated a light directing device; a control unit comprising a memory and a processor; a vehicle sensor configured to detect a vehicle; and a traffic signal detector configured to detect a change of status of a traffic signal, wherein the control unit is in communication with the light projector, the light-directing device, the vehicle sensor, and the traffic signal detector; and the memory comprises instructions which, if executed, cause the light projector to emit light toward the detected vehicle. In some embodiments, the light projector, the light-directing device, and the control unit are comprised in a signaling unit. In some embodiments, the vehicle sensor is a camera.

In some embodiments, the instructions are executed when the traffic signal detector detects the change of status of the traffic signal. In some embodiments, the change of status of the traffic signal comprises an activation of a green light of the traffic signal and the traffic signal detector comprises a photo sensor. The photo sensor can detect emission from the green light of the traffic signal, or the traffic signal detector can directly detect a light change signal via a connection to the traffic signal.

In embodiments, the traffic light assistance system further comprises a housing, wherein the signaling unit is positioned within the housing. In other embodiments, the light projector, the light-directing device, and the control unit are positioned within the housing. The housing is attached to the base of the traffic light, adjacent to the traffic light or anywhere sufficiently proximate to the intersection to detect the vehicle and alert the vehicle operator.

In some embodiments, detecting the vehicle comprises detecting any portion of the vehicle, an item within the vehicle, a person within the vehicle, or an operator of the vehicle. In some embodiments, the traffic light assistance system, the signaling unit, the light projector, or any combination thereof, is configured to project light toward a proximity of an operator of the vehicle.

In embodiments, the light projector emits visible light, preferably having a wavelength from 490 nm to 575 nm. The light projector can comprise a laser or an LED. In some embodiments, the light projector further comprises a diffuser. The light emitted from the light projector can have a strength that varies with a direct relationship to an ambient brightness, which can be detected by a photoresistor or a light sensor, or in some embodiments, the vehicle sensor.

In some embodiments, the light-directing device comprises: a first motor or actuator, wherein the first motor rotates the light projector such that emission from the light projector is movable along an X axis; and a second motor or actuator, wherein the second motor rotates the light projector such that emission from the light projector is movable along a Y-axis. Alternatively, the light-directing device can comprise a single multidirectional motor, such as a spherical motor. In some embodiments, the light projector is attached to the light-directing device, such that movement of the light-directing device directly adjusts the directional output of the light projector (e.g., the light projector being directly mounted to a motor system). In some embodiments, the light projector remains stationary and change of light direction is achieved by e.g. attaching a mirror to the light-directing device; in such embodiments, movement of the light-directing device causes a change of position of the mirror mounted thereto.

In some embodiments, the control unit is in a wired communication with at least one of, and potentially all of, the light projector, the light-directing device, the vehicle sensor, and the traffic signal detector. In some embodiments, the control unit is in a wireless communication with at least one of, and potentially all of, the light projector, the light-directing device, the vehicle sensor, and the traffic signal detector In some embodiments, the wireless communication comprises infrared communication, Bluetooth®, or radio.

In some embodiments, the control unit is configured to track motion of the vehicle, perform pattern recognition, or any combination thereof. In certain embodiments, the memory comprises instructions that, when executed, track motion of the vehicle. In certain embodiments, the memory comprises instructions that, when executed, performs pattern recognition to identify the vehicle.

In some embodiments, the light emitted from light projector, the light emitted from the signaling unit, the light emitted from the traffic light assistance system, or any combination thereof, is less than 5 mW, less than 1 mW, or less than 0.5 mW. In some embodiments, the emitted light is below the Nominal Ocular Hazard Distance (NOHD) when it is in contact with the vehicle. In some embodiments, the emitted light is at or below 2.5 mW per cm², at or below 1 mW per cm², or at or below 0.5 mW per cm² when it contacts the vehicle. In some embodiments, the emitted light is below 100 microwatts per cm² when it contacts the vehicle. In some embodiments, the emitted light is below 5 microwatts per cm² when it contacts the vehicle. In some embodiments, the emitted light is below 50 nanowatts per cm² when it contacts the vehicle.

The emitted light can comprise a static beam or a non-static beam. In some embodiments, the non-static beam is a blinking beam, a flashing beam, or a pulsing beam. In certain embodiments, the non-static beam has a frequency less than 3 hertz. In some embodiments, the emitted light is patterned and pulsing light, where a patterned light is configured to project a pattern of the emitted light toward the vehicle and can be formed using a mask.

In some embodiments, the signaling unit or the light projector further comprises a dimmer 120 and/or a diffuser. In some embodiments, the signaling unit or the light projector further comprises a shaping diffuser. In some embodiments, the traffic light assistance system further comprises a fail-safe configured to prevent activation of the light projector in absence of a diffuser or when the diffuser is broken.

In various embodiments, this disclosure provides a method of using the traffic light assistance system described above. In various embodiments, this disclosure provides a method of communicating to an operator of a vehicle, the method comprising: detecting the vehicle with a vehicle sensor; detecting a change of status of a traffic signal with a traffic signal detector; and projecting light toward the vehicle using a light projector and a light-directing device. In some embodiments, the light projector is attached to the light-directing device. In some embodiments, the light projector, the light-directing device, and the control unit are comprised within a signaling unit.

In various embodiments, this disclosure provides a kit comprising: a light projector and light-directing device; a control unit comprising a memory and a processor, wherein the memory comprises instructions which, if executed, cause the light projector to emit light toward a detected vehicle; a vehicle sensor; and a traffic signal detector configured to detect a change of status of a traffic signal. In some embodiments, the light projector is configured to be attached to the light-directing device.

To the accomplishment of the foregoing and related ends, certain illustrative aspects of the claimed subject matter are described herein in connection with the following description and the associated drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

The systems, devices and methods may be better understood by referring to the following description in conjunction with the accompanying drawings, in which like numerals indicate like structural elements and features in various figures. The components in the figures are not necessarily to scale, and simply illustrate the principles of the systems, devices and methods. The accompanying drawings illustrate only possible embodiments of the systems, devices and methods and are therefore not to be considered limiting in scope.

FIG. 1 depicts an embodiment of a traffic light assistance system installed in connection with a traffic light and potentially alerting a driver to a change in the status of the traffic light.

FIG. 2 an image of a vehicle driver alerted by the light projected from an embodiment of a traffic light assistance system.

FIG. 3 is a block diagram of an embodiment of the traffic light assistance system.

FIG. 4 is a block diagram of an embodiment of a control unit of the traffic light assistance system of FIG. 3.

FIG. 5 depicts an embodiment of a light projecting device for the traffic light assistance system of FIG. 1.

FIG. 6 depicts the beam of light projected from an embodiment of the traffic light assistance device into the interior of a vehicle cabin.

FIG. 7 depicts an embodiment of a traffic light assistance system installed with a traffic light.

FIG. 8 depicts another embodiment of a traffic light assistance system installed with a traffic light.

FIG. 9 illustrates another placement of an embodiment of the traffic light system in connection with the traffic signal.

FIG. 10 is a flowchart of an embodiment of a method for improving traffic flow.

FIG. 11A is a front view of an embodiment of a housing of the traffic light assistance system of FIG. 1.

FIG. 11B is a side view of an embodiment of a housing of the traffic light assistance system of FIG. 1.

FIG. 12A depicts an embodiment of the traffic light assistance system attached to a mast head.

FIG. 12B depicts an embodiment of the traffic light assistance system attached to a mast head.

FIG. 12C depicts an embodiment of the traffic light assistance system attached to a traffic light.

### DETAILED DESCRIPTION

Aspects of the system and methods are described below with reference to illustrative embodiments. The references to illustrative embodiments below are not made to limit the scope of the claimed subject matter. Instead, illustrative embodiments are used to aid in the description of various aspects of the systems and methods. The description, made by way of example and reference to illustrative reference is not meant to be limiting as regards any aspect of the claimed subject matter.

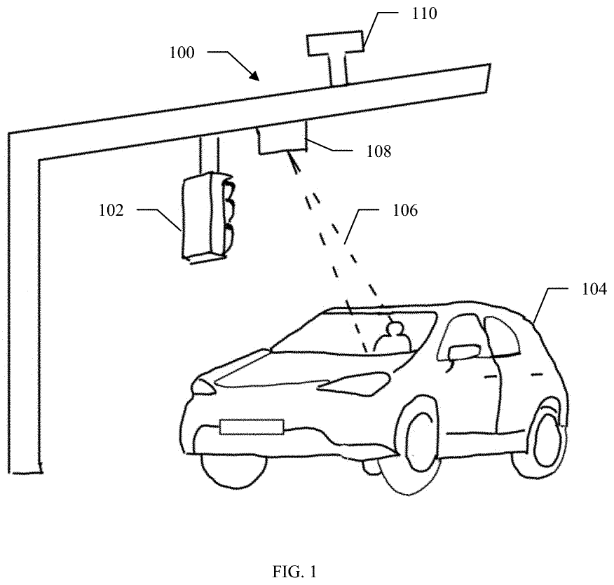

Turning now to FIG. 1, an embodiment of a traffic light assistance system 100 is depicted, installed with a traffic signal 102, also referred to as a traffic light, and alerting a vehicle 104. The traffic light assistance system 100 is also referred to as the “system” herein. The illustrated traffic light assistance system 100 can be configured to alert occupants of a vehicle 104 to a change of traffic signal status. There are many distracted or inattentive drivers on the roadways, leading to delays, frustration, dangerous driving conditions, and lost productivity nationwide. Drivers frequently try to take advantage of the time they are stopped at traffic lights to check their mobile devices, delaying their reaction to the light change. The traffic light assistance system 100 provided can facilitate a reduction of such delays by, e.g., alerting the driver that the traffic signal 102 has turned green. In some circumstances, drivers are unable to see the change in traffic light 102 due to their position relative to the light or the position of the sun behind the light. Conventional traffic lights have a blind spot or dark spot proximate to the traffic light 102, where the angle between the light and the car prevents or impairs a driver's ability to see the traffic light 102. Alternatively, the roof of the vehicle 104 itself may prevent a driver from easily seeing the traffic light 102. When cars are sufficiently close to the traffic light 102, the driver is at a difficult angle to look up and see the light itself. In other circumstances, for example on an east-west road, during particular times of the day, the sun may appear to be behind the traffic light 102, making it difficult for the drivers to look at the traffic light 102. The traffic light assistance system 100 can eliminate the problems caused by blind spots and/or dark spots of current traffic lights, keeping traffic flowing and avoiding potential delays or problems.

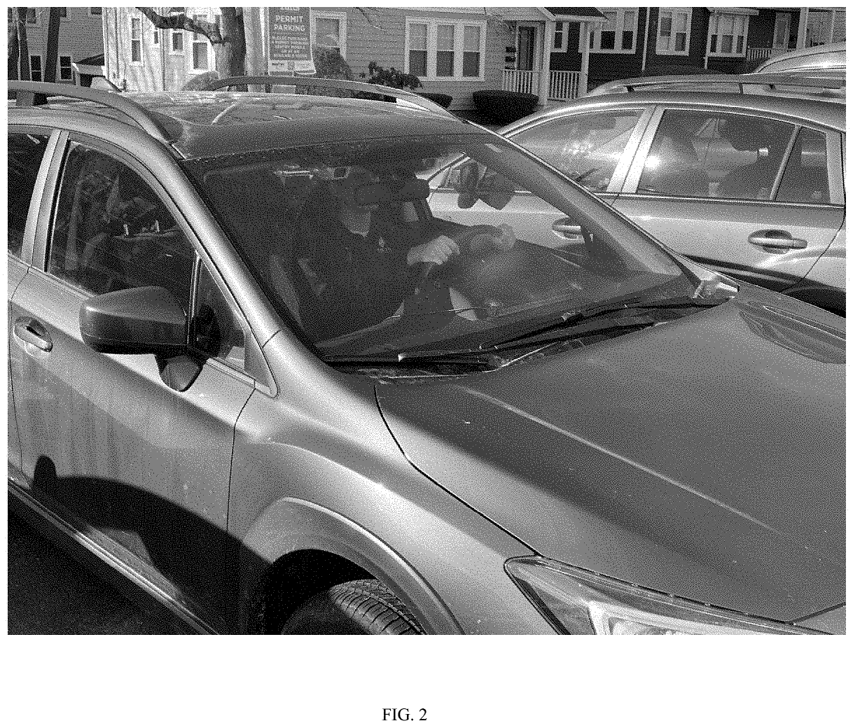

As shown in FIG. 2, in some embodiments, the traffic light assistance system 100 alerts a driver by sending a beam of light 106 focused on the vehicle 104 or into the cabin of the vehicle 104. The projected beam of light 106 is more likely than traditional traffic lights to alert the driver, as it can be aimed at the specific vehicle 104, or a portion of the specific vehicle 104, including but not limited to, the interior cabin of the vehicle 104. This allows for a much stronger or more intensely focused beam of light 106 than the light from the traffic light 102 itself to arrive at the vehicle 104 with relatively low power consumption, and without distraction to other vehicles 104, or the light pollution issues that would arise from covering an entire intersection with a light of similar strength. As seen in FIG. 2, the projected beam of light 106 from the traffic light assistance system 100 is of sufficient intensity and focus as to form a visible image on the vehicle 104 or interior of the vehicle 104 or even the driver. In contrast, the light from the traffic light 102 is sufficiently diffuse that while it may provide some illumination to the intersection, unless ambient light levels are very low, reflection of the traffic light off the vehicle 104 or interior of the vehicle 104 is not readily apparent to a driver. In embodiments of the traffic light assistance system 100, the image of the beam of light 106 from the system 100 projected onto the vehicle 104 or interior and reflected is easily visible to the driver. In embodiments a laser or light emitting diode (“LED”) projector can be used create the beam of light 106.

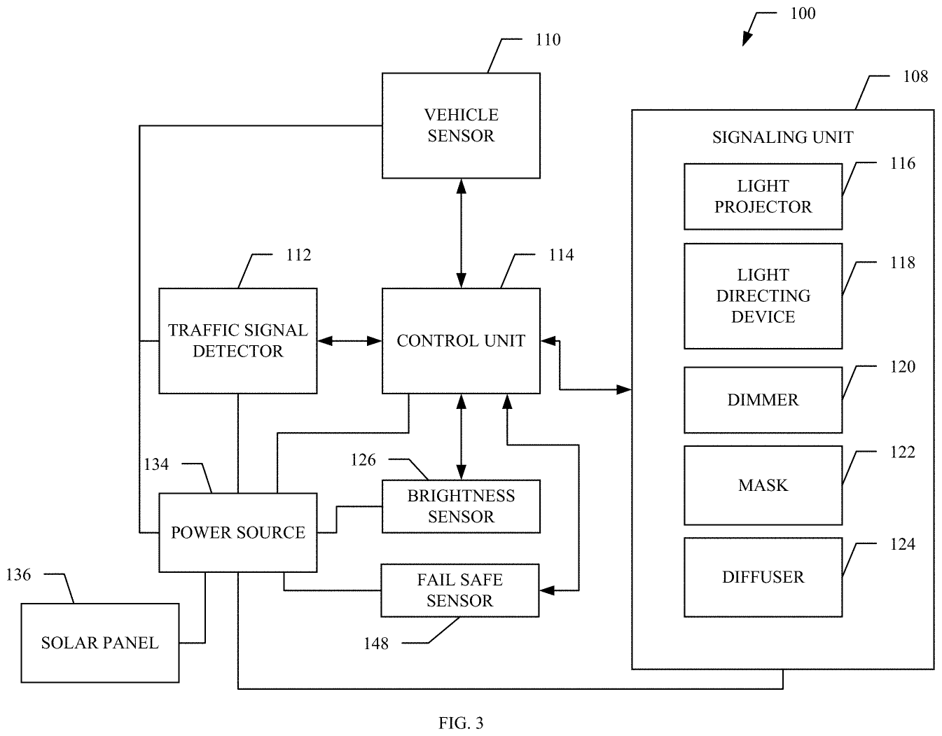

Referring now to FIG. 3, in some embodiments, the traffic light assistance system 100 comprises: a signaling unit 108 that signals the driver of a vehicle 104, a vehicle sensor 110 that detects one or more vehicles proximate to the traffic light 102, a traffic signal detector that detects a change or upcoming change in status of a traffic light, and a control unit 114 that directs operation of some or all of the traffic light assistance system 100. In some embodiments, the signaling unit 108 includes a light projector 116 configured to create or emit the beam of light 106, and a light directing device 118 configured to aim or direct the beam of light 106 toward a specific location, such as a selected vehicle 104 or vehicle interior. The signaling unit 108 or light projector 116 can also include a dimmer 120 that controls the intensity of the beam of light 106 emitted from the light projector 116 and one or masks 122 that control the pattern of the beam of light 106. In embodiments, the traffic light assistance system 100 can include a brightness sensor 126, where data from the brightness sensor 126 can be used to determine the appropriate intensity of the beam of light 106, which can then be controlled via the dimmer 120. The vehicle sensor 110 can be configured to detect the location of one or more vehicles 104 approaching or stopped at the traffic signal 102. The traffic signal detector 112 detects the status or a change in status of the traffic signal 102 such that the current status of the traffic light 102 can be identified. As used herein, traffic light status is the illumination of the light, e.g. green, red or yellow light, or flashing green, red or yellow light. In some embodiments, the control unit 114 is configured to identify the particular light status based upon data received from the traffic signal detector 112 and determine appropriate steps to alert drivers to the traffic light status. For example, the control unit 114 can direct the light projector 116 to emit the beam of light 106 and direct said light via the light directing device toward a specified location. The control unit 114 can identify the particular location based at least in part upon data received from the vehicle sensor 110. The projected beam of light 106 can alert the driver of the vehicle 104 to the change in status of the traffic signal 102. In embodiments, the traffic light assistance system 100 can also include a brightness sensor 126 to detect ambient levels of light and a dimmer 120 capable of adjusting the strength of the beam of light 106 projected by the traffic light assistance system 100 based upon ambient light levels, as described in detail below.

The traffic light assistance system 100 can operate with traffic signals or traffic lights that are both on the near and far side of the intersection. With the help of the traffic light assistance system 100, drivers will no longer need to stop far behind the stop line so that they can see the traffic lights 102. This will allow more cars to pass through each intersection reducing traffic congestion. The traffic light assistance system 100 can also make stopping before and driving through intersections safer and more comfortable for those with limited mobility who cannot simply move their entire body to their dashboard to see the traffic light change. Additionally, it will help alert distracted drivers to the traffic light change.

In some embodiments, the traffic light assistance system 100 further comprises a power source 134, which can be implemented as a battery. In some embodiments, the control unit 114 is connected to a battery power source 134. In certain embodiments, the battery is connected to a solar panel 136 capable of charging the battery to power some or all of the traffic light assistance system 100. In some embodiments, the traffic light assistance system 100 is powered via a direct connection to the same power source 134 that powers the traffic light 102. In some embodiments, the traffic light assistance system 100 is connected to a power source 134 that powers the traffic light 102 and also comprises a battery as described herein. In some embodiments, the traffic light assistance system 100 is directly wired to a traffic box to draw power from said traffic box.

### Vehicles

As used herein, a vehicle 104 includes, but is not limited to, an automobile, a truck, an emergency service vehicle, a bicycle, a moped, a scooter, or a motorcycle. In some embodiments, the traffic light assistance system 100 emits light toward a single, detected vehicle 104. In some embodiments, the traffic light assistance system 100 comprises a plurality of light projectors 116 and is configured to emit light toward a plurality of detected vehicles 104. In some embodiments, the traffic light assistance system 100 comprises a single light projector 116 wherein the beam is configured such that it can illuminate a plurality of detected vehicles 104, whether by projecting a beam of light 106 sufficiently wide to illuminate a plurality of detected vehicles 104, or by redirecting the beam of light 106 to alert multiple vehicles 104 in rapid succession.

In some embodiments, the vehicle that will be alerted by the traffic light assistance system 100, referred to as the detected vehicle 104, is the vehicle 104 closest to the stop-line of an intersection. The vehicle 104 to be alerted can be the vehicle 104 within a given lane that is the closest to the stop-line of an intersection. In some embodiments, a plurality of vehicles 104 can be alerted, such as the first vehicle 104 in each lane that are closest to the stop-line of the intersection. By selectively communicating to the operator of the first vehicle 104 (as opposed to the second, third, or later vehicle operators), the traffic light assistance system 100 selectively alerts an occupant or operator therein. By alerting the first vehicle 104 of the change in traffic light status, the first vehicle 104 will proceed through the intersection more expeditiously than in the absence of the traffic light assistance system 100; the additional vehicles 104 (e.g., second, third, or later vehicles) behind the first vehicle 104 are also likely to proceed more expeditiously through the intersection, as the movement of the vehicle(s) in front of them can alert them of a change of status of the traffic signal 102.

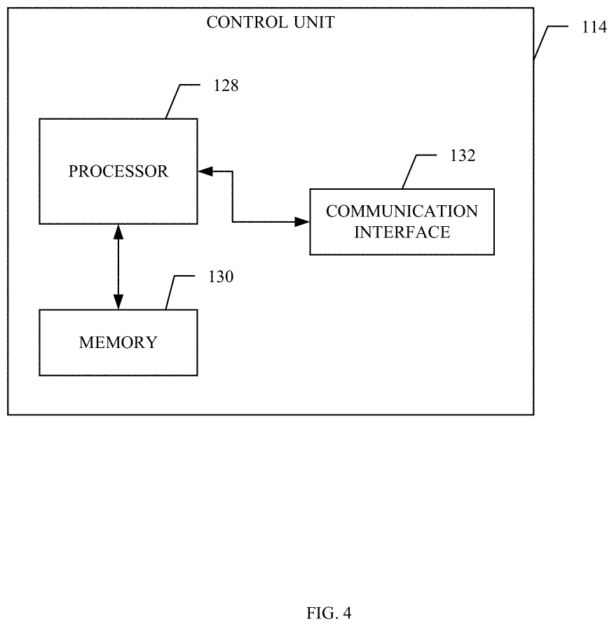

Turning now to FIG. 4, the control unit 114 directs operation of the traffic light assistance system 100. In some embodiments, the control unit 114 comprises a memory 130 and a processor 128, wherein the memory 130 stores instructions that, when executed by the processor 128, cause the traffic light assistance system 100 to emit light toward a detected vehicle, alerting the operator of the vehicle to the change in status of the traffic light 102. In embodiments, the control unit 114 includes a communication interface 132 in wired or wireless communication with at least one of the light projector 116, the light-directing device, the vehicle sensor 110, a brightness sensor 126, and the traffic signal detector 112. Wireless communication can comprise infrared communication, a short-range wireless technology (e.g., Bluetooth®), radio, Wi-Fi, a cellular network, or any other suitable communication network. Instructions in the memory 130 can be updated remotely via the communication interface 132. In other embodiments, operation of the traffic light assistance system 100 can be remotely controlled via the communication interface 132 and the control unit 114.

While the control unit 114 and signaling unit 108 are shown as separate blocks in FIGS. 3 and 4, in other embodiments, the light projector 116, the light directing device 118, and the control unit 114 are comprised in the signaling unit 108. In some embodiments, the light projector 116 is directly attached to the light directing device 118, allowing a single device to accomplish the directing and projecting capabilities of both the light projector 116 and light directing device 118.

In certain embodiments, the control unit 114 is configured to detect the vehicle 104, or a portion of the vehicle 104 (e.g., a hood, a window, a dashboard, a roof, an outline of the vehicle, or any other portion of the vehicle) based at least in part upon data received from the vehicle sensor 110. In some embodiments, the control unit 114 is configured to detect one or more items within the vehicle 104 including the dashboard, steering wheel, an occupant of the vehicle, an operator of the vehicle, and/or a transponder located within a vehicle 104. The control unit 114 can determine the position of the vehicle 104 based at least in part upon data from the vehicle sensor 110 and signal the light directing device 118 to control the beam of light 106 emitted from the light projector 116 to illuminate the vehicle 104 or a portion thereof.

In addition to detecting and signaling stopped vehicles 104, in some embodiments, the control unit 114 is configured to track motion of a detected vehicle 104 as it approaches the traffic light 102. The control unit 114 can use the vehicle sensor data from tracking the motion of detected vehicles 104 to identify the vehicle or vehicles 104 closest to the traffic light 102 and can direct the light projector 116 to aim the beam of light 106 at that vehicle or vehicles in particular. The control unit 114 can then determine a location of said vehicle 104 and apply this information to control the light directing device 118 such that light emitted from the traffic light assistance system 100 is projected toward the detected vehicle 104.

In some embodiments, the control unit 114 is configured perform pattern recognition or to otherwise recognize a pattern or object based at least in part upon data received from the vehicle sensor 110. The object can be a vehicle 104, a portion of the vehicle 104, an occupant of the vehicle 104, an operator of the vehicle 104, or any combination thereof. In some embodiments, the control unit 114 is configured to perform image recognition. As a non-limiting example, the control unit 114 can detect a vehicle 104 with the vehicle sensor 110 based on a recognized pattern or image. In some embodiments, the control unit 114 can then determine a location of said vehicle 104 and apply this information to control the light directing device 118 such that light emitted from the traffic light assistance system 100 is projected toward the detected vehicle 104.

In some embodiments, the control unit 114 can be trained to better identify vehicles 104, collect data to enhance performance, or it can receive updates to improve vehicle recognition. In some embodiments, the communication interface 132 uploads data gathered relating to pattern and/or image recognition and/or downloads data relating to pattern and/or image recognition. As a non-limiting example, the traffic light assistance system 100 can be updated with new pattern recognition data by communicating such updated information via the communication interface 132, and such data can thereafter be stored in the memory 130. In some embodiments, the communication interface 132 is configured to receive direct input of data (e.g., via connected data transmitters such as USB and microchip). In some embodiments, the communication interface 132 is configured to receive indirect input of data (e.g., via indirect data transmission, such as through WIFI, cellular, satellite, or Bluetooth®).

As used herein, memory 130 is interchangeable with any similar storage device. In some embodiments, the memory 130 comprises a physical apparatus used to store data or programs on a temporary or permanent basis. Memory 130 can comprise volatile memory or non-volatile memory, including but not limited to, flash memory, dynamic random-access memory, ferroelectric random-access memory and phase-change random access memory. In some embodiments, the memory comprises CD-ROM, DVD, flash memory, a magnetic disk drive, a magnetic tape drive, an optical disk drive, cloud computing-based storage or any combination thereof.

In embodiments, the processor 128 is a single core or multi core processor, or a plurality of processors for parallel processing. The processor 128 can be a microprocessor including but not limited to a general-purpose central processing unit (CPU), a special-purpose processor, or a microcontroller. In some embodiments, the memory 130 comprises instructions to be executed by the processor 128 to perform any of the methods described herein. As a non-limiting example, in some embodiments the processor 128 described herein causes the traffic light assistance system 100 to activate a vehicle sensor 110, detect a vehicle 104 with the vehicle sensor 110, activate a traffic signal detector 112, detect a change of status of the traffic signal 102 with a traffic signal detector 112, activate a light projector 116, activate a light directing device 118, project light toward the vehicle 104, move a direction of the projected light, or any combination thereof. In some embodiments, the memory 130 contains instructions that analyzes data from the vehicle sensor 110 and/or the traffic signal detector 112, and provides instructions to direct light toward a detected vehicle 104, a window of the detected vehicle 104, or an operator of the detected vehicle 104

### Signaling Unit

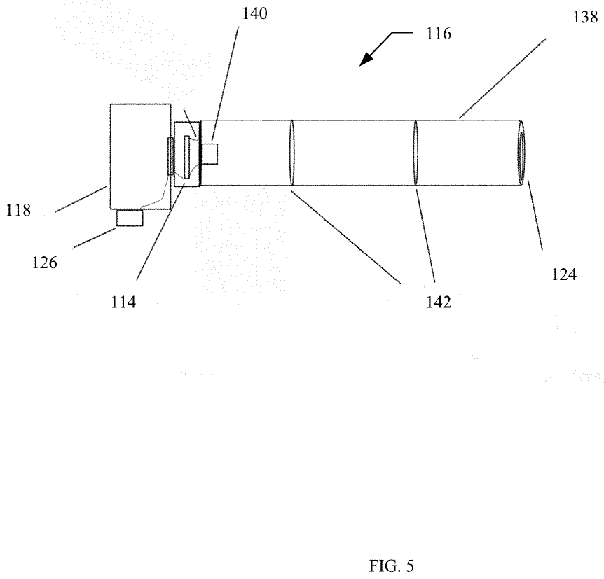

Turning now to FIG. 5, the light projector 116 emits light which, when directed toward a detected vehicle 104, can get the attention of an operator of the detected vehicle 104. In embodiments, the light projector 116 comprises a light emitter 140 that produces light and one or more lenses 142 in an optics housing 138, which work together to focus the emitted light. The signaling unit 108 differs from a typical traffic light 102 in that the beam of light 106 projected by the light projector 116 is a significantly stronger and/or more focused beam than the light emitted by a typical traffic light 102. While a traffic light 102 is designed to be visible to a significant portion of a road that leads to the intersection, in embodiments, each beam of light 106 that is projected by the light projector 116 only covers an area that is not significantly more than one vehicle 104. This allows for a much stronger or more focused beam to be utilized to alert the driver. Utilizing a strong or focused beam of light 106 would allow the light to be detectable to the vehicle operator over the level of ambient light, even when deflected off an object within the vehicle 104. Ensuring that such a strong or focused beam is emitted and directed at the vehicle 104 can avoid wasteful power consumption, distraction, and light pollution issues that would occur if one simply replaced a traditional traffic light 102 with high powered lights and flooded the entire intersection with a similar level of light per area as that emitted by the light projector 116.

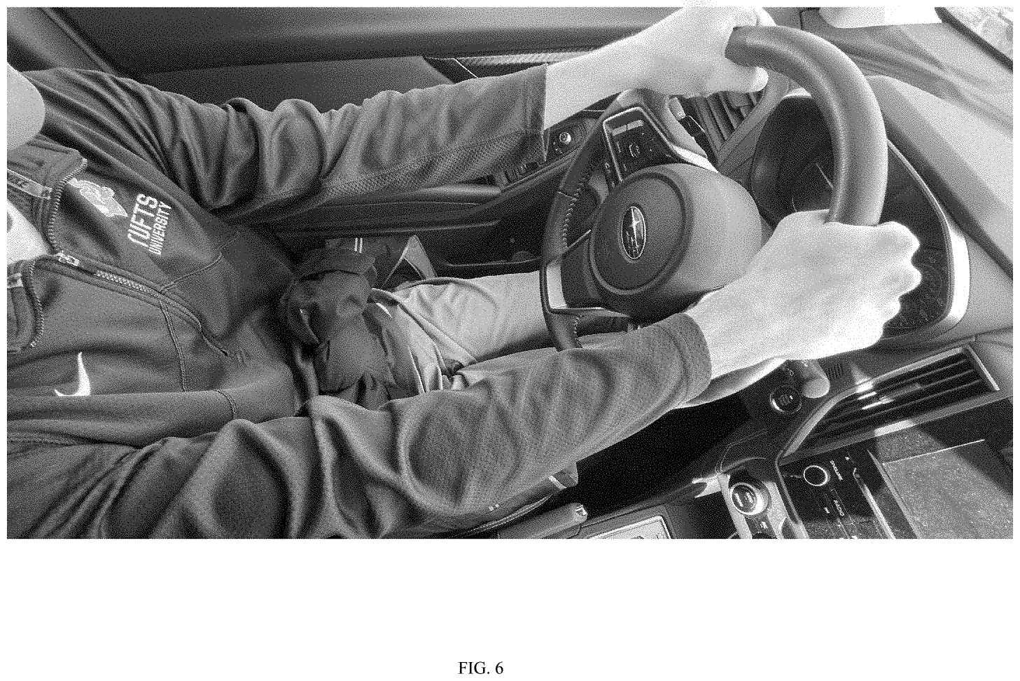

Referring to FIGS. 5 and 6, as a non-limiting example, signaling units 108 disclosed herein can include a light projector 116 or light emitter 140 that comprises a green laser, and the traffic light directing device can be configured to focus or direct the green laser light toward a detected vehicle 104 upon a change of status of the light signal (e.g., when the traffic light turns green), indicating that the operator of the vehicle should begin acceleration of the vehicle 104. The appearance of the green light on the dashboard or the hand or body of the vehicle operator can alert the operator more effectively than the change of traffic light status itself. For example, when the vehicle 104 is in the blind or dark spot for the traffic light 102, the operator may be unable to see the traffic light itself. The beam of light 106 from the traffic light assistance system 100 appearing within the cabin of the vehicle 104 may be the only indicator of the traffic light status change that the operator can easily see. The ambient light from the traffic light 102 itself is unlikely to be bright enough to illuminate the vehicle 104, while the beam of light 106 from the traffic light assistance system 100 can be sufficient strong and/or focused to be easily visible to the operator of the vehicle 104.

Turning once again to FIG. 5, as another non-limiting example, light projectors 116 or light emitters 140 disclosed herein can include a red laser, and the traffic light assistance system 100 can be configured to emit red light toward a detected vehicle 104 given a status of the light signal (e.g., when the traffic light turns red), warning the vehicle 104, who may be moving the vehicle 104 while the light is still red or who may be approaching the intersection at high speed despite the light being red, to stop.

In embodiments, the light projector 116 comprises a laser projector. In other embodiments, the light projector 116 or light emitter 140 comprises a light emitting diode (LED) projector. However, any light source capable of providing sufficient strong and/or focused light can be used to implement the light emitter 140 or light projector 116. In some embodiments, the light emitter 140 emits light having a wavelength from 490 nm to 575 nm. In preferred embodiments, the light emitter 140 emits a green light having a wavelength of 532 nm or 555 nm. In some embodiments, the light projector 116 emits an orange or red light having a wavelength from 620 nm to 750 nm. In a preferred embodiment, the light projector 116 emits a red light having a wavelength of 635 nm.

In an embodiment, the light projector 116 can include an optics housing 138 and light emitter 140, implemented here as one or more LEDs in a cylindrical optics housing 138. The light projector 116 can include one or more lenses 142 that focus light emitted from the LED or LEDs, intensifying the light so it can be projected into the vehicle 104. A mask 122 can be positioned in or on the optics housing 138 and can shape the beam of light 106 created by the light projector 116 to form a distinctive pattern. The control unit 114 can be positioned behind the LED(s) and the light directing device 118 can be implemented as one or more actuators or motors connected to the optics housing 138 and capable of moving the housing to direct the beam of light 106. A brightness sensor 126 can be attached below the light directing device 118.

In some embodiments, the traffic light assistance system 100 includes a diffuser 124 (e.g., an optical diffuser). The diffuser 124 can be incorporated as part of the signaling unit 108 and can be applied to facilitate the diffusion of light, ensuring the beam of light 106 from the light projector 116 is scattered in a manner that covers a sufficiently broad area to alert the operator of a vehicle 104, and to ensure safety of the emitted light. For example, the beam of a laser light is diffused such that the emitted light is not harmful to the eyes of the operator when it contacts the vehicle 104 or operator of the vehicle 104. In other embodiments, light emitted from the light projector 116 has a strength that is not harmful to the human eye, regardless of the presence of the diffuser 124. As provided herein, the strength of the emitted light is measured as of its intensity when in contact with the detected vehicle or operator of said vehicle.

In some embodiments, the light emitted from the light projector 116, the light emitted from the traffic light assistance system 100, or any combination thereof, has an intensity that varies with a direct relationship to an ambient brightness. For example, when ambient brightness is low (such as in the evening), the light emitted from the traffic light assistance system 100 can be relatively low and yet sufficient to get the attention of the operator of the vehicle 104; in contrast, when ambient brightness is high (such as in the middle of a sunny day), the light emitted from the traffic light assistance system 100 can be relatively high to ensure there is sufficient brightness to get the attention of the operator. In some embodiments, the ambient brightness is detected using the vehicle sensor 110, for example the ambient brightness can be detected using a camera that is configured to detect vehicles 104. In other embodiments, the ambient brightness is detected using a separate brightness sensor 126. The brightness sensor 126 can be a lux sensor, a photoresistor, a light sensor, an illuminance meter, or any other sensor capable of registering ambient light. In some embodiments, the level of light emitted from the light projector 116 in response to the detection of ambient brightness is controlled with a dimmer 120, as described further below.

In some embodiments, the light emitted from light projector 116, the light emitted from the signaling unit 108, the light emitted from the traffic light assistance system 100, or any combination thereof, is less than 5 mW, less than 1 mW, or less than 0.5 mW. In some embodiments, the emitted light is below the Nominal Ocular Hazard Distance (NOHD) when it is in contact with the detected vehicle 104 and/or in contact with an occupant of the detected vehicle 104. In some embodiments, the emitted light is at or below 2.5 mW per cm², at or below 1 mW per cm², or at or below 0.5 mW per cm² when it contacts the vehicle 104 and/or an occupant of the vehicle 104. In some embodiments, the emitted light is below 100 microwatts per cm² when it contacts the vehicle 104 and/or an occupant of the vehicle 104. In some embodiments, the emitted light is below 5 microwatts per cm² when it contacts the vehicle 104 and/or an occupant of the vehicle 104. In some embodiments, the emitted light is below 50 nanowatts per cm² when it contacts the vehicle 104 and/or an occupant of the vehicle 104.

The beam of light 106 projected by the traffic light assistance system 100 can be static or non-static. In some embodiments, the non-static beam is a blinking beam, a flashing beam, or a pulsing beam. In some embodiments, the non-static beam has a frequency less than 10 hertz, less than 5 hertz, less than 4 hertz, less than 3 hertz, less than 2 hertz, or less than 1 hertz. In certain embodiments, the non-static beam has a frequency less than 3 hertz. The frequency of the non-static beam can be specifically selected to avoid causing seizures in humans.

In other embodiments, the emitted light comprises a moving beam, where the moving beam can move across a portion of the vehicle 104 and/or occupant of the vehicle 104 to catch the attention of the driver or occupant. In embodiments, the beam can be moved by the light-directing device by movement of a mask 122 placed in front of the light projector 116, or by another moving component, such as a lens or mirror.

In some embodiments, the emitted light is patterned light. Non-limiting examples of ways that a patterned light can be formed include using a mask 122, a prism, a diffuser 124, or an aperture positioned in front of the light projector 116. The pattern can comprise a plurality of parallel lines, a plurality of overlapping lines, a hash pattern, a checkered pattern, a plurality of shapes (non-limiting examples of which include a plurality of dots, a plurality of squares, a plurality of stars, etc.), or any combination thereof. As a non-limiting example, a mask 122 placed between the light projector 116 and the vehicle 104 can produce a pattern displayed on the vehicle 104. In some embodiments, the patterned light is also a moving beam. In some embodiments, the moving beam rotates the pattern of the patterned light.

In some embodiments, the emitted light can be: (i) either static or non-static; (ii) moving or non-moving; (iii) patterned or non-patterned, or any combination of any one from each of (i), (ii), or (iii). As a non-limiting example, the emitted light can be a static patterned beam that does not move across the vehicle 104 (e.g., the projected pattern remains in substantially the same place on the vehicle 104). In some embodiments the emitted light is a non-static (e.g., flashing) patterned beam that does not move across the vehicle 104 (e.g., the projected pattern remains in substantially the same place on the vehicle 104 but flashes with a frequency). In other embodiments the emitted light is a static patterned beam that moves across the vehicle 104 (e.g., the projected pattern (such as a hash pattern) can rotate in a circular manner or otherwise move relative to the vehicle 104).

As illustrated in FIG. 5, the signaling unit 108 is used to direct emission from the light emitter 140 toward a detected vehicle 104. In some embodiments, the light directing device 118 is directly attached to the light projector 116, and moves the light projector 116 or the entire signaling unit 108 to alter the direction of the beam of light 106. In some embodiments, the light directing device 118 comprises a motor or actuator to directly alter the direction of emission of the light projector 116. In some embodiments, the light-directing device includes one or more motors or actuators that rotate the signaling unit 108 or light projector 116, such that emission from the light projector 116 is movable along an X-axis, a Y-axis, or a combination thereof. In other embodiments, the light-directing device comprises a first motor/actuator and a second motor/actuator that, when combined, are capable of rotating the light projector 116 such that its emission is movable along both an X-axis and a Y-axis. In some embodiments, the light-directing device comprises a single multidirectional motor or a spherical motor.

In other embodiments, the light 118 directing device is neither connected to nor directly moves the signaling unit 108 or the light projector 116, and instead is capable of directing the beam of light 106 even while the signaling unit 108 and/or light projector 116 remains stationary. For example, in some embodiments the light directing device 118 comprises a movable mirror configured to direct light emitted from the light projector 116 toward a detected vehicle 104. The movable mirror can comprise a mirror attached or connected to the light directing device 118. The light directing device 118 can comprise one or more motors or actuators that, when combined, are capable of rotating the mirror such that light emission is movable along both an X-axis and a Y-axis. As another non-limiting example, in some embodiments the light directing device 118 comprises a movable lens, or a plurality of lenses 142 comprising at least one movable lens, configured to direct light emitted from the light projector 116 toward a detected vehicle 104. In some embodiments, the movable lens comprises a lens attached or connected to the light directing device 118 as described herein. In some embodiments, the traffic light assistance system 100 is configured such that light emitted from the traffic light assistance system 100 can be directed along both an X-axis and a Y-axis.

### Vehicle Sensor

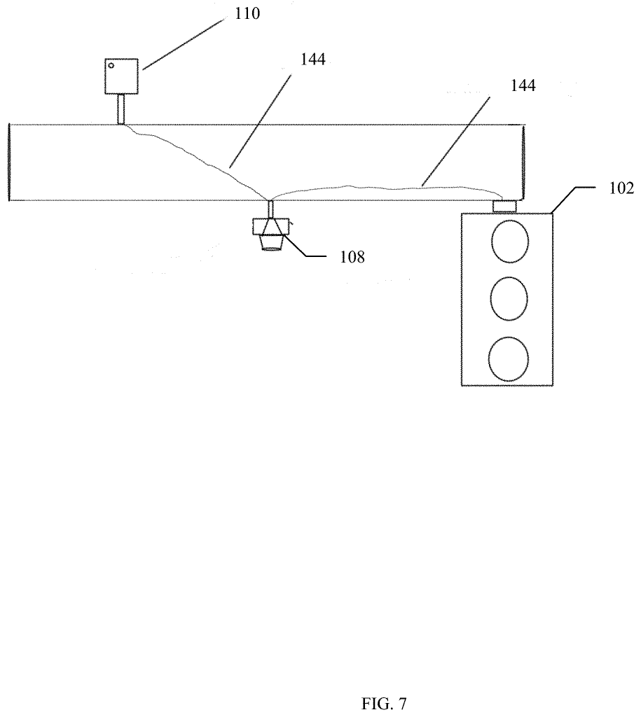

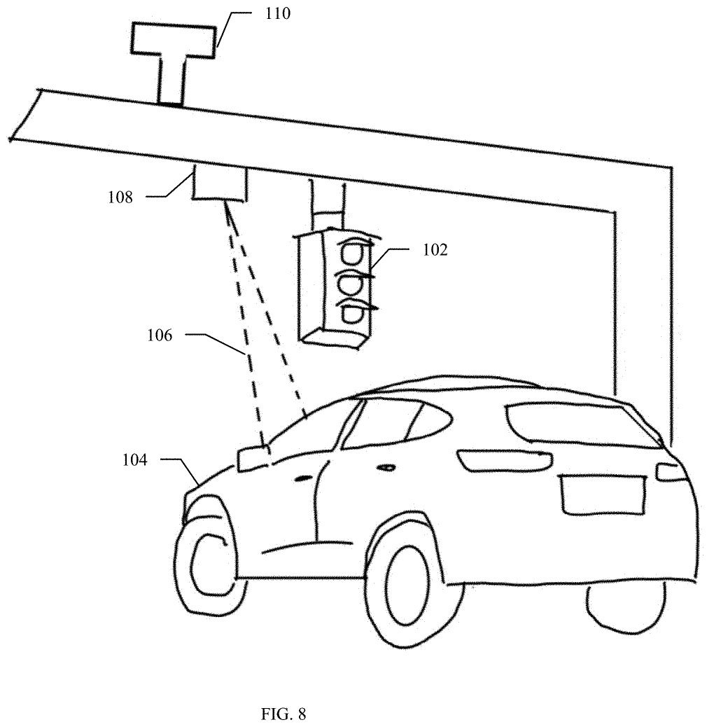

Turning now to FIGS. 7 and 8, as provided herein, the vehicle sensor 110 is used to detect one or more vehicles 104 in proximity to an intersection having a traffic signal 102. As shown in the illustration the vehicle sensor 110 can be wired 144 to the signaling unit 108, which can be connected to the traffic signal detector 112 as well. The vehicle sensor 110 and signaling unit 108 can be positioned on and attached to the arm that supports the traffic signal 102.

In some embodiments, the vehicle sensor 110 is a camera. In other embodiments, the vehicle sensor 110 comprises a lidar device, a radar device, an infrared sensor, an inductive loop created by a coil of wire embedded in the road, or any other sensor system capable of detecting the presence of a vehicle 104. In some embodiments, the vehicle sensor 110 determines location of the vehicle 104 and passes said location data to the control unit 114. In some embodiments, the control unit 114 is configured to analyze the data provided by the vehicle sensor 110 to determine the location of the vehicle 104 relative to the traffic light assistance system 100, the traffic light 102, the intersection, or any other part of an intersection. In some embodiments, the vehicle sensor 110 determines whether the detected vehicle 104 is in motion by, for example, the data provided by the vehicle sensor 110

### Traffic Signal Detector

As provided herein, the traffic signal detector 112 detects a signal or a change in signal status from the traffic light 102. For example, the traffic signal detector 112 can detect the activation of a green light of the traffic signal 102, or the deactivation of a red light of the traffic signal 102. Changes of status of the traffic light 102 include activation of a green light, deactivation of a green light, activation of a yellow light, deactivation of a yellow light, activation of a red light, and deactivation of a red light.

In some embodiments, the traffic signal detector 112 comprises a photo sensor configured to detect the change of status of the traffic signal 102. As a non-limiting example, a photo sensor can be configured to detect emission from the green light of a traffic signal 102, such that when the traffic signal green light is activated, the traffic signal detector 112 observes this change of status, thereby activating the traffic light assistance system 100, and directing light toward a detected vehicle 104. The photo sensor can be placed such that it can sense the change of status of the traffic signal 102, including but not limited to, within 2 feet, within 1 foot, or within 6 inches of a light of the traffic signal 102. The photo sensor may be placed at further distances so long as it can detect a change of status of the traffic signal 102. In some embodiments, the photo sensor can be configured to detect the absence of emission from a light of a traffic signal 102, such that when the red traffic signal light is deactivated, the traffic signal detector 112 observes this change of status, and activates the traffic light assistance system 100, and directing light toward a detected vehicle 104. In other embodiments, a timer can be used in conjunction with the traffic signal detector 112 to determine when the traffic light 102 changes to green. For example, if the traffic signal detector 112 detects a change to a red light, the control unit 114 can be programmed with the timing of the traffic light cycle and activate the system 100 directing light toward a detected vehicle 104 when the traffic light 102 is predicted to turn green.

In other embodiments, the traffic signal detector 112 directly detects a light change signal, such as electrical signal from the traffic light or traffic light control box via a connection to the traffic signal 102. As a non-limiting example, in some embodiments the traffic signal detector 112 is a component that detects an electrical signal sent to the green light of the traffic light 102, indicating activation of the green light. In other embodiments, said traffic signal detector 112 can also, or in the alternative, detect the absence of an electrical signal. As a non-limiting example, the traffic signal detector 112 can be a component (e.g., a transducer) that detects when an electrical signal ceases to be sent to the yellow and/or red lights of a traffic signal 102, thus indicating activation of the green light. In some embodiments, such traffic signal detector 112 is a sensor that can detect the presence and/or absence of energy in a wire (e.g., the wire sending power to the green light, corresponding with activation of the green light).

### Dimmer and Fail-Safe Components

In some embodiments, the traffic light assistance system 100 further comprises a dimmer 120 configured to control the intensity of emitted light. The light projector 116 and/or the signaling unit 108 further can comprise a dimmer 120. In some embodiments, the dimmer 120 controls intensity of emitted light by adjusting power provided to the light projector 116. In other embodiments, the dimmer 120 comprises a filter between the light projector 116 and the vehicle 104 and the dimmer 120 can control intensity by adjusting the amount of filter applied. As a non-limiting example, the dimmer 120 can comprise a plurality of neutral density filters, or a variable neutral density filter placed between the emitted light and the detected vehicle 104. In other embodiments, the dimmer 120 comprises a sliding barrier that, e.g., allows the light projector 116 to emit more light when the opening is wider, and limits light when in a narrow position. The control unit 114 can control the dimmer 120 to regulate the intensity of light emitted from the traffic light assistance system 100.

In some embodiments, the traffic light assistance system 100 further comprises a fail-safe 148 to increased safety in the operation, use of, and exposure to the system 100. The fail-safe 148 can include one or more sensors that detect when the traffic light assistance system 100 is operating in an unsafe or unusual manner. In some embodiments, the fail-safe 148 is configured to prevent activation of the light projector 116 in absence of a diffuser 124 or when the diffuser 124 is damaged, broken, or ineffective light projector 116. For example, a constant electrical circuit could connect the diffuser 124 to the 114 control unit, such that when the circuit is interrupted, the control unit 114 would not allow the light projector 116 to emit the beam of light 106. In some embodiments, the fail-safe 148 is configured to prevent activation of the light projector 116 in absence of a dimmer 120 or when the dimmer 120 is damaged, broken or ineffective. As a non-limiting example, in some embodiments prolonged exposure to light emitted directly from the light projector 116 may be harmful to a human eye, and a diffuser 124 and/or dimmer 120 is present in the traffic light assistance system 100 in part to reduce the intensity of light that contacts the vehicle 104 and/or the occupants therein; the fail-safe 148 prevents activation of the light projector 116 when such diffuser 124 and/or dimmer 120 is missing or damaged.

### Location of System

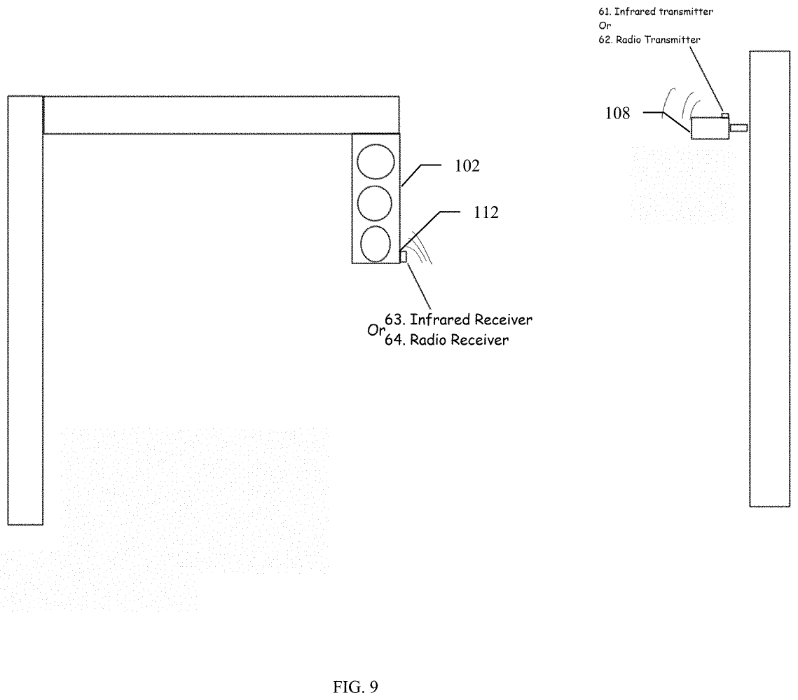

Turning now to FIG. 9, conveniently, the disclosed traffic light assistance system 100 may be located anywhere within a proximity of an intersection so long as the traffic light assistance system 100 is in operable communication with a traffic light signal (e.g., it can detect that the signal has turned green) and it is in operable communication with a vehicle 104 at the intersection (e.g., it can emit light toward the vehicle 104 to alert the operator of the vehicle 104). As a non-limiting example, in some embodiments the signaling unit 108 is attached to an object remote from the traffic light 102, such as a pole located within the vicinity of the intersection at which the traffic light is. As a non-limiting example, the traffic light 102 may be mounted by span wires, and the signaling unit 108 may be mounted to a stationary object to maintain improved accuracy in windy conditions. As another non-limiting example, the traffic light 102 may be mounted to a mast arm, and the signaling unit 108 may be mounted at another location along the same mast arm, or to another object within the general vicinity, so long as light emissions remain directable toward the detected vehicle 104s.

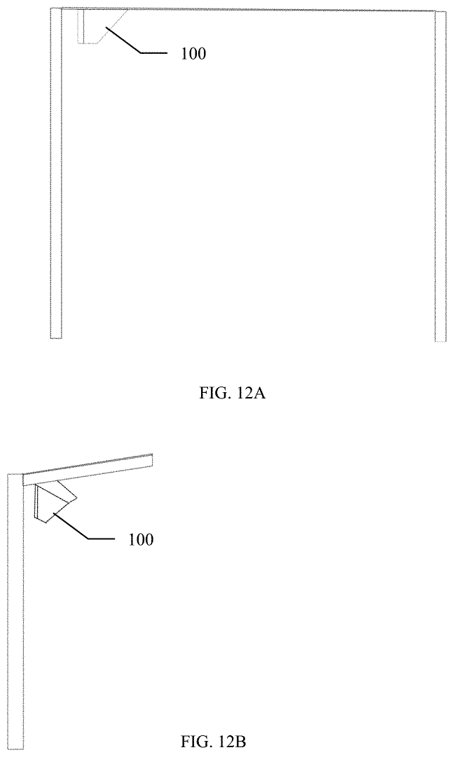

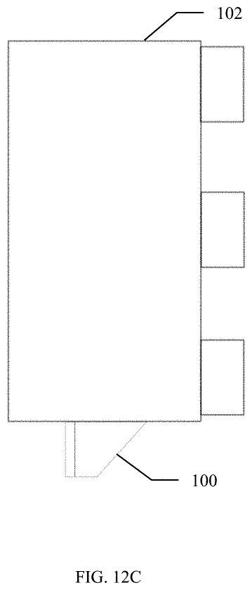

In some embodiments, the traffic light assistance system 100 is directly attached to a traffic light 102. In other embodiments, the signaling unit 108 is attached to the traffic signal 102. In some embodiments, the signaling unit 108 is attached to the base (i.e., bottom), side or top of the traffic signal 102. As a non-limiting example, as illustrated in FIG. 12A a portion of the traffic light assistance system 100 in a housing 146 that mounts onto the bottom portion of a traffic light 102. The traffic light assistance system 100 projects light from the front and the bottom the housing.

In some embodiments, the light projector 116 is attached to the traffic light 102. While in other embodiments, the light projector 116 is positioned remote from the traffic light 102. For example, the light projector 116 can be attached to an object remote from the traffic light 102, such as a pole located within the vicinity of the intersection of the traffic light 102. The traffic light 102 may be mounted by span wires, and the light projector 116 may be mounted to a stationary object to maintain improved accuracy in windy conditions. As another non-limiting example, the traffic light 102 may be mounted to a mast arm, and the light projector 116 and/or the light-directing device may be mounted at another location along the same mast arm, or to another object within the general vicinity, so long as light emissions remain directable toward the detected vehicles 104. In other embodiments, the light projector 116 is attached to the traffic signal 102. In some embodiments, the light projector 116 and/or the light-directing device is attached to the base (i.e., bottom), side or top of the traffic signal 102.

### Housing

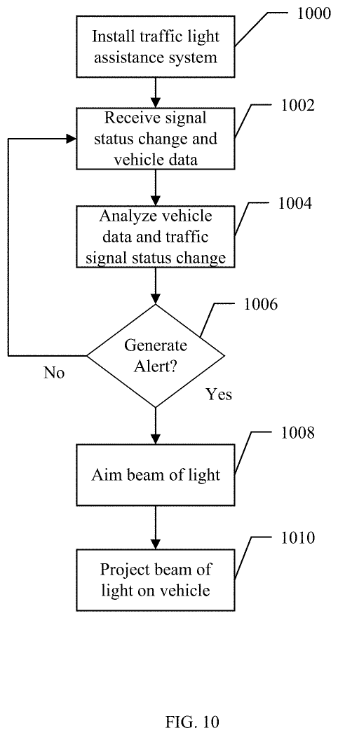

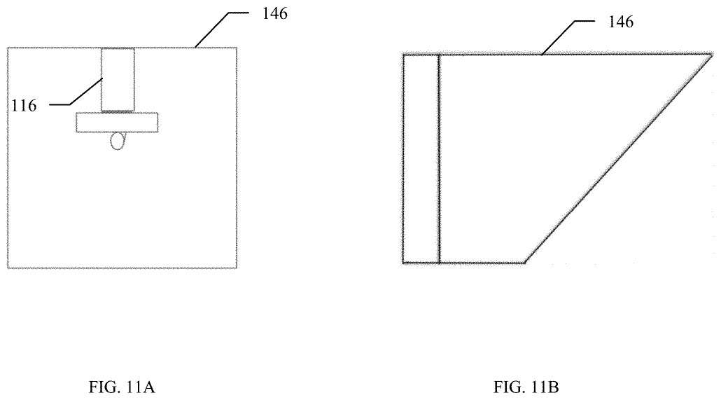

Turning now to FIGS. 11A and 11B, in some embodiments, one or more components of the traffic light assistance system 100 are enclosed, or contained at least in part, by a housing 146. In some embodiments, the signaling unit 108 and/or the control unit 114 are positioned within the housing 146. The housing 146 can be water resistant or water-proof and can be designed to protect the more sensitive elements of the system 100 from weather, interference, or vandalism.

Referring to FIGS. 12A through 12C, in some embodiments, the housing 146 is attached to the traffic light 102 itself In other embodiments, the housing 146 is positioned remote from the traffic light 102. For example, the housing 146 can be attached to an object remote from the traffic light 102, such as a pole located within the vicinity of the intersection. The traffic light 102 may be mounted by span wires or cables, and the housing 146 may be mounted to a stationary object to maintain improved accuracy in windy conditions. Alternatively, the traffic light 102 may be mounted to a mast arm, and the housing 146 can be mounted adjacent to the traffic light 102 or at another location along the same mast arm, or to another object within the general vicinity, so long as light emissions remain directable toward the detected vehicles 104. In other embodiments, the housing 146 is attached to the traffic light 102, whether the base (i.e., bottom), side or top of the traffic light 102.

In some embodiments, the entirety of the traffic light assistance system 100 is comprised within the housing 146. In this example, the housing 146 comprises the light projector 116, the vehicle sensor 110 (e.g., a camera), the traffic signal detector 112 (e.g., via component detecting the signal indicating activation of a green light of the traffic light), and the control unit 114. In other embodiments, one or more of the components of the traffic light assistance system 100 are remote from one another. For example, the vehicle sensor 110 (e.g., a camera) may be placed in any location where it may detect a vehicle 104 while traffic signal detector 112 (e.g., a photo sensor) may also be placed in a separate location where it may detect a change of status of the traffic light 102.

### Method of Assisting Traffic Flow

While, for purposes of simplicity of explanation, the methods are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the disclosed methods. It is to be appreciated that the functionality associated with the blocks may be implemented by software, hardware, a combination thereof, or any other suitable means (e.g., device, system, process, component and so forth). Additionally, it should be further appreciated that the disclosed methods are capable of being stored on an article of manufacture to facilitate transporting and transferring such methods to various devices.

Turning now to FIG. 10, an embodiment method for alerting an operator of a vehicle 104 to change in traffic light status is illustrated. At step 1000, a traffic light assistance system 100 is installed in connection with a traffic signal 102. During installation a light projector 116 is installed or placed at or near an intersection such that the light projector 116 can project light at vehicles 104 that are at or near the intersection. At least one vehicle sensor 110 is installed at, or near, the traffic signal 102 such that a vehicle 104 that is at, near, or approaching the intersection can be detected. Similarly, a traffic signal detector 112 is placed such that in a way that the signal detector 112 can detect or communicate with the traffic signal 102 and receive the current status, or changes to the status, of the traffic signal 102. A control unit 114 for the traffic light assistance system 100 is installed in wired or wireless communication with the light projector 116, the vehicle sensor 110, and the traffic signal detector 112.

In embodiments, after installation at step 1002, the control unit 114 will receive data regarding the current status of the traffic signal 102 via the traffic signal detector 112, as well as one or more of: the position, velocity, type, or other data related to a vehicle 104 through the vehicle sensor 110. At step 1004, the control unit 114 will analyze the received traffic signal data and vehicle data to identify and/or predict when a vehicle 104 will be stopped at a red light, and the traffic light 102 transitions to green. If the control unit 114 determines that it is not necessary to generate an alert for a vehicle operator at step 1006, it will continue to analyze data from the vehicle sensor 110. However, if it detects that an alert will be needed or useful at step 1006, the control unit 114 will signal the light projector 116 to project a light. Directing the light projector 116, can include instructions to the light directing device 118 to aim the beam of light 106 to be light projected by the light projector 116 at the vehicle 104 at step 1008. The control unit 114 can signal the light emitter 140 to emit the beam of light 106 at step 1010.

A non-limiting example of a combination of the status of the vehicle 104 and the status of the traffic signal that would cause a control system 100 to act is when the traffic light 102 turned green, or has turned green for a certain period of time, and a vehicle 104 remains significantly motionless at or near the intersection. Another nonlimiting example is when the traffic light 102 turned red, or is about to turn red, and a vehicle 104 is approaching the intersection at high speed. In some embodiments, the light projector 116 is always on and may or may not be communicating with the control unit 114. In that case, the control unit 114 reacts by directing the light at a vehicle 104 when a set situation occurs.

### Kits

This disclosure provides kits comprising the components for assembling the traffic light assistance system 100 disclosed herein. In some embodiments, this disclosure provides a kit comprising: light projector 116 comprising a light emitter 140 and a light directing device 118, a control unit 114 comprising a memory 130 and a processor 128, and a vehicle sensor 110 In some embodiments, the light emitter 140 is configured to be attached to the light directing device 118. In some embodiments, the kit further comprises components for attaching the traffic light assistance system 100 to a traffic signal 102. In some embodiments, the kit further comprises components for attaching the traffic light assistance system 100 to a location remote from the traffic signal 102.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Additionally, the headings are provided to assist the reader and are not to be considered limiting or as restricting the subject matter. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim. As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form.

What is claimed is:

1. A traffic light assistance system, comprising:
a vehicle sensor configured to detect a vehicle proximate to a traffic light and generate vehicle data;
a traffic signal detector configured to detect a change of status of the traffic light;
a signaling unit configured to project a beam of light to alert an operator of the vehicle to the change of status of the traffic light; and
a control unit programmed to receive a traffic light status signal from the traffic signal detector based at least in part on the change of status of the traffic light, determine a location associated with the vehicle based at least in part upon vehicle data, and direct the signaling unit to aim and project the beam of light toward the location associated with vehicle.

2. The traffic light assistance system of claim 1, wherein the signaling unit comprises an LED projector.

3. The traffic light assistance system of claim 1, wherein the signaling unit comprises a laser.

4. The traffic light assistance system of claim 3, further comprising a diffuser configured to diffuse the beam of light that is emitted by the laser.

5. The traffic light assistance system of claim 1, wherein the beam of light comprises a non-static beam.

6. The traffic light assistance system of claim 4, wherein the non-static beam moves in a pattern across at least part of the location associated with the vehicle.

7. The traffic light assistance system of claim 1, wherein the signaling unit comprises:
a light projector that emits the beam of light; and
a light-directing device that aims the beam of light, wherein the light-directing device moves the light projector such that the beam of light is movable along an X axis and a Y axis.

8. The traffic light assistance system of claim 1, wherein the signaling unit comprises:
a light emitter that produced the beam of light; and
a light-directing device that directs the beam of light, wherein the light-directing device comprises a multidirectional motor.

9. The traffic light assistance system of claim 1, wherein the vehicle sensor comprises a camera.

10. The traffic light assistance system of claim 1, wherein the control unit comprises:
a memory encoded with instructions that, when executed, cause the traffic light assistance system to detect the vehicle using object recognition; and
a processor that executes the instructions.

11. The traffic light assistance system of claim 1, wherein the control unit comprises:
a memory encoded with instructions that, when executed, cause the traffic light assistance system to detect the vehicle using motion detection; and
a processor that executes the instructions.

12. The traffic light assistance system of claim 1, wherein the signaling unit further comprises a mask that results in a preselected pattern for the beam of light.

13. The traffic light assistance system of claim 1, wherein the signaling unit comprises a diffuser that diffuses the beam of light.

14. The traffic light assistance system of claim 13, further comprising a fail-safe device configured to prevent the signaling unit from emitting the beam of light when the diffuser fails to function.

15. The traffic light assistance system of claim 1, wherein the traffic signal detector comprises a photosensor that detects a green light signal from the traffic light.

16. The traffic light assistance system of claim 1, wherein the traffic signal detector detects an electrical signal sent to or through the traffic signal, wherein the electrical signal indicates a change in the status of the traffic signal.

17. A method for facilitating flow of traffic at a traffic light, comprising:
detecting a location of a vehicle stopped at the traffic light;
detecting change of status in the traffic light to a green light; and
directing a beam of light toward at least a portion of the vehicle to alert an operator of the vehicle to the change of status of the traffic light, wherein the beam of light is aimed based at least in part upon the location of the vehicle.

18. The method of claim 17, further comprising:
sensing an ambient light level; and
adjusting the intensity of the beam of light based at least in part upon the ambient light level so that the beam of light is visible to the operator of the vehicle.

19. The method of claim 17, wherein directing the beam of light comprises moving a light project that emits the beam of light to focus the beam of light at a location associated with the vehicle.

20. A traffic light assistance system, comprising:
a vehicle sensor that generates vehicle data based upon a vehicle proximate to a traffic light;
a signaling unit that comprises:
a light projector that emits a beam of light; and
a light directing device that aims the beam of light at a location associated with position of the vehicle;
a traffic signal detector that identifies a change of status in the traffic light and generates traffic signal data;
a control unit that comprises a processor and memory, the memory encoded with instructions that cause the processor to analyze the vehicle data to identify the location associated with position of the vehicle and based upon the traffic signal data and directs the signaling unit to aim and emit the beam of light at the location.
